(19) United States
(12) Patent Application Publication
(10) Pub. No.: US 2005/0287421 A1
(43) Pub. Date: Dec. 29, 2005

(54) Electrochemical cell having a carbon aerogel cathode

(75) Inventors: Bernard Simon, Le Taillan Medoc (FR); Michel Hilaire, St. Medard en Jalles (FR); Christophe Jehoulet, Ambares & Lagrave (FR); Jean-Francois Cousseau, Poitiers (FR)

Correspondence Address: SUGHRUE MION, PLLC, 2100 PENNSYLVANIA AVENUE, N.W., SUITE 800, WASHINGTON, DC, 20037, US

(73) Assignee: SAFT

(21) Appl. No.: 11/159,213

(22) Filed: Jun. 23, 2005

(30) Foreign Application Priority Data
Jun. 25, 2004 (FR) 0406998

(51) Int. Cl. H01M 4/96; H01M 6/14

(52) U.S. Cl. 429/44; 429/101; 429/345; 429/346

(57) ABSTRACT

The invention provides an electrochemical cell having a liquid positive material and comprising a metal anode and a carbon-based cathode, the cell being characterized in that the cathode comprises a carbon aerogel.

### TECHNICAL FIELD

The invention relates to an electrochemical cell having a carbon aerogel cathode. In the cathode, such a cell contains an electrochemically active compound that is liquid.

### STATE OF THE ART

So-called “liquid cathode” electrochemical cells of Li/SOCl₂ type are known, and conventionally comprise a lithium anode and a carbon cathode, the positive active liquid being found in the pores of the cathode. Conventional cathodes comprise grains of carbon black that are compressed together in the presence of a binder, conventionally polytetrafluoroethylene (PTFE). Nevertheless, such cells present a problem in storage, particularly at high temperature, i.e. a passivation layer forms on the surface of the lithium anode which then resists passing lithium ions during discharging.

This passivation leads to a transient polarization peak, known as a “voltage delay”, that appears in the form of a transient drop in voltage at the beginning of discharging.

Cells that do not present this problem of a transient polarization peak are therefore being researched.

U.S. Pat. Nos. 6,530,655, 5,601,938, and 5,429,886 describe porous gas diffusion electrodes for fuel cell applications, said electrodes comprising a carbon aerogel. Carbon aerogel is stated as presenting good electrical conductivity.

JP 9 328 308 describes a capacitor electrode comprising a carbon aerogel for the purpose of increasing the speed with which the capacitor charges and discharges.

U.S. Pat. No. 5,393,619 describes an electronically conductive separator placed between two adjacent electrodes of two cells in series in order to reduce the size of the module created in that way, said electrodes possibly being made of carbon aerogel.

None of the above documents deals with liquid cathode electrochemical cells, nor with the problem of passivation of the lithium anode.

None of the above documents teaches or describes the cell of the invention.

### SUMMARY OF THE INVENTION

The invention thus provides an electrochemical cell having a liquid positive material and comprising a metal anode and a carbon-based cathode, the cell being characterized in that the cathode comprises a carbon aerogel.

### BRIEF DESCRIPTION OF THE FIGURES

FIG. 1 shows the voltage values measured across the terminals of “14500” cylindrical cells (AA format) fabricated using different implementations of the invention, 0.2 milliseconds (ms) after the beginning of discharging for a duration of 1 second at a current of C/50 at the temperature of a thermostatically controlled enclosure. By way of comparison, FIG. 1 also shows the voltage values measured under the same discharge conditions across the terminals of a reference cell fitted with a cathode constituted in accordance with the prior art by compressed grains of carbon black. Both types of cell were previously stored together in an enclosure that was thermostatically controlled in alternation to spend one week at 20° C. and the following week at 45° C. After the 14th week, the storage temperatures became 20° C. and 65° C. instead of 20° C. and 45° C. The discharge current pulse was applied at the end of the week's storage at the storage temperature.

FIG. 2A shows the voltage values measured across the terminals of cells fabricated in accordance with different implementations of the invention and also across the terminals of the reference cell, during the test discharge performed at the end of the 12th week, i.e. after a week of storage at 45° C.

FIG. 2B shows the voltage values measured across the terminals of cells fabricated in accordance with different implementations of the invention and also across terminals of the reference cell, during the test discharge performed at the end of the 15th week, after a week of storage at 20° C.

FIG. 2C shows the voltage values measured across the terminals of cells fabricated in accordance with different implementations of the invention, and also across the terminals of the reference cell, during the test discharge, undertaken at the end of the 16th week after a week of storage at 65° C.

FIG. 3 shows the voltage values measured across the terminals of button format cells fabricated in accordance with different implementations of the invention, while discharging them at a rate of C/300 at 20° C. By way of comparison, FIG. 3 also shows the voltage values measured under the same discharge conditions across the terminals of a reference cell of the same format, having a cathode constituted in accordance with the state of the art by compressed grains of carbon black.

### DETAILED DESCRIPTION OF EMBODIMENTS OF THE INVENTION

The cell of the invention includes in conventional manner an outer metal can. The cell of the invention may be of cylindrical format, prismatic format, or button format. For a cell of cylindrical format, the electrode mount is of the coil type. With that type of mount, a cylindrical anode is inserted in the can at its periphery. The anode metal is any suitable metal in the art of liquid cathode cells, and mention can be made of alkali and alkaline earth metals, and alloys thereof. Lithium is preferred. A separator is placed on the anode and is capable of withstanding the electrolyte, for example a glass fiber separator. A cylindrical cathode is inserted into the remaining space. A metal cover is bonded to the top of the can.

The electrolyte is introduced through a hole formed in the metal cover. The electrolyte conventionally comprises a salt that may be selected, for example from: chlorate, perchlorate, trihalogenoacetate, halide, (boro)hydride, hexafluoroarsenate, hexafluorophosphate, (tetra)chloroaluminate, (tetra)fluoroborate, (tetra)-bromochloroaluinate, (tetra)bromoborate, tetrachlorogallate, closoborate, and mixtures thereof. Tetrachloroaluminate or tetrachlorogallate salts are preferred for thionyl chloride. This salt is generally a metallic salt (generally using the metal of the anode), however it is also possible to use ammonium salts, in particular tetraalkylammonium. The preferred salt is a lithium salt. The salt concentration lies in the range 0.1 M to 2 M, and preferably in the range 0.5 M to 1.5 M.

The solvent of the electrolyte is constituted by a liquid or gaseous oxidizer, e.g. selected from the group consisting of: SOCl₂, SO₂, SO₂Cl₂, S₂Cl₂, SCl₂, POCl₃, PSCl₃, VOCl₃, VOBr₂, SeOCl₂, CrO₂Cl₂, and mixtures thereof. For a positive material in the form of a gas, it is conventional to use such materials dissolved in co-solvents, such as aromatic and aliphatic nitriles, DMSO, aliphatic amines, aliphatic or aromatic esters, cyclic or linear carbonates, butyrolactone, aliphatic or aromatic amines, said amines being primary or secondary or tertiary, and mixtures thereof. Aliphatic nitriles such as acetonitrile are preferred. The dissolved concentration of positive material corresponds in general to saturation, and it generally lies in the range 60% to 90% by weight of the electrolyte.

The preferred positive material is SOCl₂ or SO₂ or indeed SO₂Cl₂, with the first two and more particularly the first being highly preferred.

The carbon cathode is the portion that characterizes the cell of the invention. The cathode comprises a carbon aerogel. The term “aerogel” is used also to cover the neighboring terms “xerogel” and “cyrogel” and “aerogel-xerogel”, or “ambigel”.

Carbon aerogels are known. By way of example, they are obtained by pyrolyzing a cross-linked polymer gel, in particular of the phenol-aldehyde resin type (in particular resorcinol-formaldehyde). More specifically, the following steps can be mentioned:

Preparing an aqueous solution of a sol of a mixture of polymer or polymer precursor and a cross-linking agent, in particular of the phenol-aldehyde resin type (in particular resorcinol-formaldehyde).

Proceeding with gelling (cross-linking) by adding a basic solution acting as a catalyst. Pore size is governed in particular by the respective concentrations by weight in the sols and the concentration of catalysts.

Depositing the gels on a plate, for example, or in a mold having the desired shape.

Advantageously proceeding with a solvent exchange operation to replace any water that might still be present with an organic solvent of the acetone type.

The method advantageously then continues with drying using sub- or supercritical carbon dioxide. (Depending on the drying method used, the gel is referred to as an aerogel (supercritical drying), a xerogel (drying by evaporation), or a cyrogel (drying by lyophilization).

Proceeding with pyrolysis at a temperature lying in the range 800° C. to 1200° C., for example, and under an inert atmosphere.

The cathode of the invention generally presents total porosity lying in the range 70% to 95% by volume. Pores known as “transport pores” corresponding to macropores and mesopores generally represent porosity lying in the range 70% to 90% of the total volume. The term “mesopores” corresponds to pores having a diameter lying in the range 2 nanometers (nm) to 50 nm, while the term “macropores” corresponds to pores having a diameter greater than 50 nm. The macro-pores or meso-pores correspond to the spaces between the particles. Total porosity and macro- or meso-porosity are measured by helium pycnometry taking respectively the relative density of the material (amorphous carbon) as being 2 and the relative density of the individual carbon particles as evaluated by small angle X-ray scattering (SAXS) as being 1.4.

The specific surface area of the macro-mesopores is measured by the nitrogen adsorption technique (t-plot technique) and the mean pore size is calculated from this value by assuming that the individual particles are spherical and mono-dispersed. In an embodiment, the specific surface area of the macro-mesopores lies in the range 30 square meters per gram (m²/g) to 100 m²/g. Such a specific surface area enables a mean voltage to be obtained when discharging at C/300 that is high (e.g. greater than 3.4V for an LiSOCl₂ cell).

Compared with conventional cathodes obtained by compressing powders, the cathode of the invention provides in particular improved pore distribution and better electron conductivity (monolithic structure).

The invention offers further advantages in addition to that of reducing the transient polarization peak. The new cathode can present other advantages such as better mechanical strength and/or better capacity per unit mass and/or better capacity per unit volume and/or greater ease in fabrication.

The polymeric gel may be synthesized in a cylindrical mold, which means that the final aerogel is directly of the dimensions required for a coil type cylindrical cell. Current collection for delivery to the outside is performed by adding a rigid metal wire during the gelling step (G for gelled) or by drilling after pyrolysis (D for drilled).

In addition, the cell of the invention also provides the advantage of presenting capacity that is greater than that of cells having a conventional cathode made of carbon black grains.

The temperature at which the cell of the invention can be used may lie in the range −50° C. to +90° C., and in particular in the range −30° C. to +70° C. The primary cell of the invention is applicable in all conventional fields, such as batteries for roaming or fixed appliances.

The following examples illustrate the invention without limiting it.

### EXAMPLES

Li/SOCl₂ cells were fabricated in two different formats: a so-called “14500” AA cylindrical format (diameter of 14 millimeters (mm), height of 50 mm); and a button format. The electrolyte salt was LiAlCl₄ at a concentration of 1.35 M. The cathodes used for tests on “14500” cylindrical format cells were as follows: all cathodes other than the reference cathode were carbon aerogels obtained by pyrolyzing aerogels of resorcinol, formaldehyde resins. The polymer aqueous gel was obtained by polycondensation of resorcinol and formaldehyde with Na₂CO₃ as a catalyst. The concentration of the catalyst determined the size distribution of the pores in the various samples. The water was subsequently exchanged for acetone by soaking in a bath for three days. The samples were subsequently dried using supercritical CO₂ for three days at 50° C. Pyrolysis was performed at 1050° C. with a 2-hour (2 h) rise in temperature and a 3 h plateau at high temperature.

Reference Cathode REF

A conventional cathode obtained by compressing particles of carbon black of sizes lying in the range 30 nm to 50 nm together with a PTFE-based binder to obtain a total porosity of 85%.

Cathode A1

Total porosity: 88.5%.

Macro-mesoporosity: 82%; mean diameter of the volume of the macro-mesopores: 535 nm.

Cathode A1-D: same as cathode A1, but “drilled”.

Cathode B1-G:

Total porosity: 86%.

Macro-mesoporosity: 80%.

Specific surface area of the macro-mesopores: 81 m²/g; mean diameter of the macro-mesopore volume: 210 nm.

Cathode I1-D:

Total porosity: 84.5%.

Macro-mesoporosity: 78%.

Specific surface area of the macro-mesopores: 11 m²/g; mean diameter of the macro-mesopore volume: 1400 run.

For button format cell testing, the cathodes used (other than the reference cathode which was obtained by rolling grains of the above referenced electrode) were disks obtained by slicing aerogel cylinders and were as follows:

Reference cathode REF:

A conventional cathode obtained by compressing particles of carbon black of sizes lying in the range 30 nm to 50 nm together with a PTFE-based binder to obtain a total porosity of 85%.

Cathode A2

Total porosity: 84.9%.

Macro-mesoporosity: 78.4%.

Specific surface area of the macro-mesopores: 36 m²/g; mean diameter of the volume of the macro-mesopores: 535 nm.

Cathode B2:

Total porosity: 83.1%.

Macro-mesoporosity: 75.9%.

Specific surface area of the macro-mesopores: 78 m²/g; mean diameter of the macro-mesopore volume: 210 nm.

Cathode H2:

Total porosity: 79.5%.

Macro-mesoporosity: 70.7%.

Specific surface area of the macro-mesopores: 29 m²/g; mean diameter of the macro-mesopore volume: 400 nm.

Cathode 12:

Total porosity: 83.2%.

Macro-mesoporosity: 75.9%.

Specific surface area of the macro-mesopores: 11 m²/g; mean diameter of the macro-mesopore volume: 1400 nm.

### Example 1

Four AA format cylindrical cells of the coil type were fabricated under the trade name “LS145OOP” having a carbon aerogel cathode, and they were subjected to thermal cycle testing. These cells had cathodes A1, A1-D, B1-G, and I1-D fabricated as described above. A reference LS14500P cell REF was also assembled.

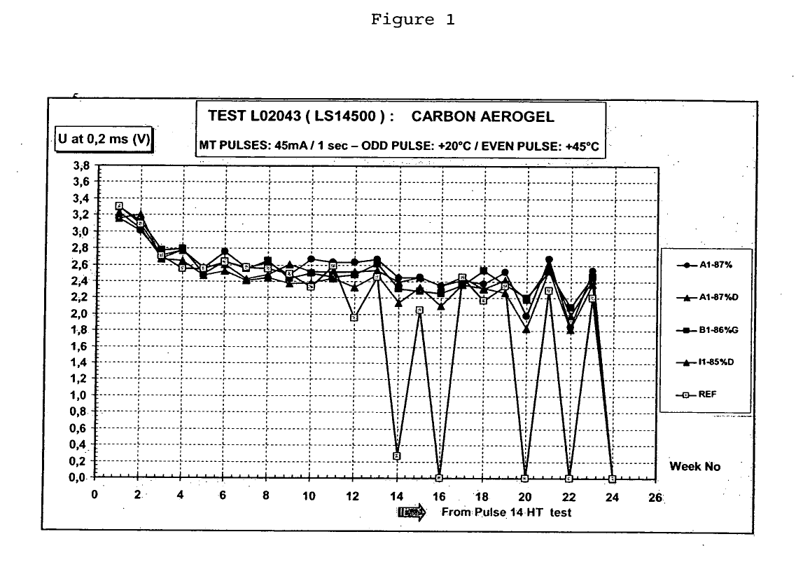

Those five cells were charged and then stored in an enclosure thermostatically controlled to 20° C. for one week. They were then discharged for one second at 20° C. The transient voltage values 0.2 ms after the beginning of discharge were measured. The cells were put back in the enclosure and stored at 45° C. for one week, and then discharged at 45° C. for one second using the same current as for the first discharge. The transient voltage values at 0.2 ms after the beginning of discharge were measured. Starting from the 14th week, the storage temperature was raised to 65° C. instead of 45° C. The repeated consecutive operations of storage at different temperatures constitutes thermal cycling of the cells interspersed with test discharge stages. The results in FIG. 1 show that from the 14th week the voltages of cells of the invention were significantly greater than the voltage from the reference cell.

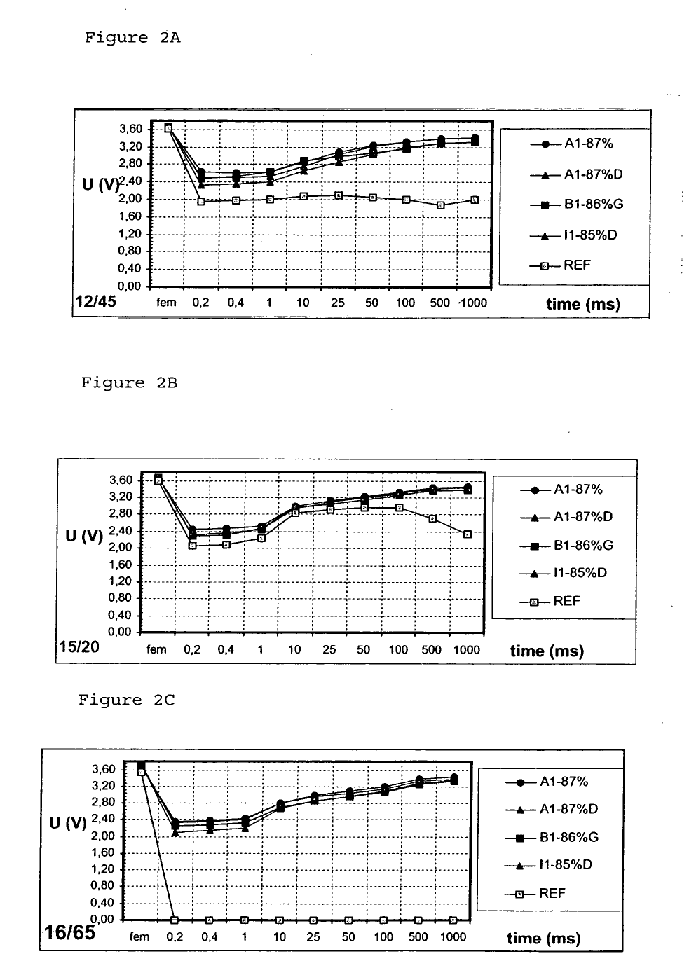

The response times were also measured at different temperatures of 20° C., 45° C., and 65° C. The results are given in FIGS. 2A to 2C. These results show that during the transient stage of voltage stabilization:
the response times of cells of the invention are shorter than the response times of the reference cell; and
the difference between the voltages of cells of the invention and the voltage of the reference cell increases with temperature.

These results show clearly the advantage of using a carbon aerogel cathode for reducing the “voltage delay” phenomenon.

### Example 2

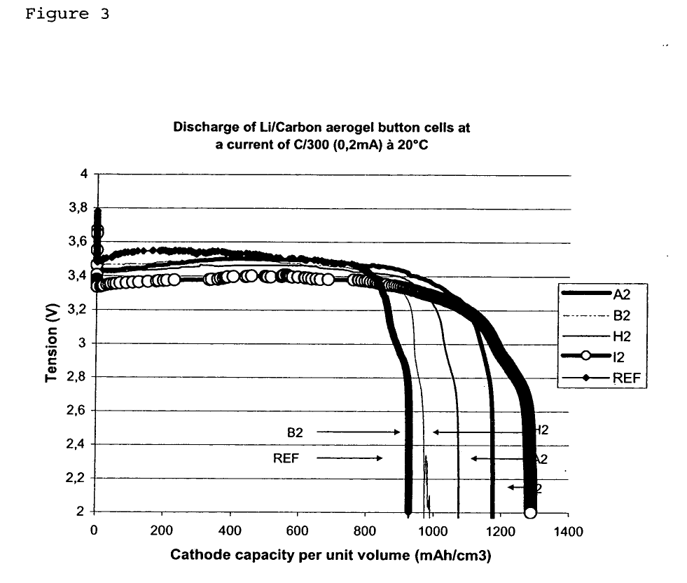

Button type cells were fabricated and a variety of cathode materials were tested (cathodes A2, B2, H2, 12, and REF). A test of discharging at C/300 was implemented at a temperature of 20° C. The discharge curves are given in FIG. 3. The results show that for cells with the cathode of the invention the capacity per unit volume is improved by about 20%. The results with the cathode 12 having the macro-mesopores with the smallest specific surface area demonstrate the improvement provided by appropriately selecting values for specific surface area.

1. An electrochemical cell having a liquid positive material and comprising a metal anode and a carbon-based cathode, the cell being characterized in that the cathode comprises a carbon aerogel.

2. A cell according to claim 1, in which the carbon aerogel of the cathode presents total porosity representing 70% to 95% by volume.

3. A cell according to claim 2, in which the carbon aerogel of the cathode presents macro-porosity and mesoporosity together representing 70% to 90% by volume compared with the total volume of the electrode.

4. A cell according to claim 1, in which the specific surface area of the pores of a size greater than 2 nm in the cathode lies in the range 30 m²/g to 100 m²/g.

5. A cell according to claim 2, in which the specific surface area of the pores of a size greater than 2 nm in the cathode lies in the range 30 m²/g to 100 m²/g.

6. A cell according to claim 1, in which the anode is a lithium anode.

7. A cell according to claim 1, in which the liquid positive material is SOCl₂.

8. A cell according to claim 1, in which the positive material is dissolved SO₂.
